(19) United States
(12) Patent Application Publication
(10) Pub. No.: US 2024/0301820 A1
(43) Pub. Date: Sep. 12, 2024

(54) MICRO GAS TURBINE DESIGNED TO LIMIT HEAT LOSSES THEREFROM

(71) Applicant: MTT Solutions B.V., Eindhoven (NL)

(72) Inventors: Victor Kornilov, Geldrop (NL); Paulus Maria Smeets, Tilburg (NL); Mark Oostveen, Veghel (NL); Marco de Later, Herkenbosch (NL); Ilian Doutchev, Den Haag (NL)

(21) Appl. No.: 18/665,680

(22) Filed: May 16, 2024

Related U.S. Application Data
(63) Continuation of application No. 16/764,872, filed on May 17, 2020, now abandoned.

(30) Foreign Application Priority Data
Nov. 20, 2017 (NL) 2019940

(51) Int. Cl. F02C 3/34; F01D 15/10; F01D 17/14; F02C 9/24

(52) U.S. Cl. CPC F02C 3/34; F01D 15/10; F01D 17/145; F02C 9/24; F05D 2250/82; F05D 2260/608; F05D 2270/02; F05D 2270/335

(57) ABSTRACT

A micro gas turbine equipped with a valve mechanism by means of which the operation of the micro gas turbine can be influenced and optimized, particularly by regulating a supply of hot gas from the cabinet and/or the exhaust of the micro gas turbine to an inlet side of the compressor. When the temperature of ambient air is relatively low, thermal output and thermal efficiency of a micro gas turbine decrease. The present micro gas turbine compensates for the loss of thermal efficiency.

### CROSS-REFERENCE TO RELATED APPLICATIONS

This is a continuation application of U.S. application Ser. No. 16/764,872 filed 17 May 2020, which Application is a National Stage Entry of International Application No. PCT/NL2018/050771 filed 19 Nov. 2018, which International Application claims the benefit of NL Patent Application No. 2019940 filed 20 Nov. 2017, the entire contents and substance of each are incorporated herein by reference in its entirety as if fully set forth below.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention relates to a micro gas turbine comprising a compressor designed to take in and pressurize gas, a combustor designed to take in pressurized gas from the compressor and to generate hot gas on the basis of fuel combustion, a turbine designed to take in and expand hot gas generated by the combustor, a generator mechanically coupled to the turbine and designed to generate electric power on the basis of mechanical power, and a controller designed to control operation of the micro gas turbine.

### 2. Description of Related Art

The present invention is in the field of gas turbines, particularly micro gas turbines. A possible application of micro gas turbines is an application for Combined Heat & Power (CHP), which does not alter the fact that other applications are feasible as well. Micro gas turbines and/or micro gas turbine based CHP systems may be used instead of conventional boilers in large houses, offices, plants, schools, stores etc., to mention one example, or may be used in hybrid electric vehicles so as to extend the range of such vehicles, to mention another example. In general, micro gas turbines are known for high reliability, low maintenance demand and low noise level, combined with high electric efficiency, low weight and low emissions.

A micro gas turbine typically comprises a compressor, a combustor and a turbine. During operation of a micro gas turbine, ambient air is drawn in and pressurized by the compressor. The compressed air is supplied to a combustor generating hot gas on the basis of fuel combustion. It is common practice to have a special type of heat exchanger called recuperator in a micro gas turbine, which in that case serves for pre-heating the air before being supplied to the combustor. From the combustor, the hot pressurized gas is supplied to the turbine where it expands and thereby provides mechanical power for both the compressor and a generator which is mechanically coupled to the turbine.

The mechanical power of the generator is used to generate electric power as a first type of output from the micro gas turbine. For the purpose of conveying the electric power to an electric power grid, the micro gas turbine is equipped with a suitable grid converter.

The expanded gas, i.e., the exhaust gas from the turbine, may be made to flow through a recuperator, as mentioned, in which case heat from the exhaust gas is used for pre-heating air compressed by the compressor, prior to supplying the air to the combustor. Further, it is possible for a micro gas turbine to comprise a gas-to-liquid heat exchanger, which in that case may be used for heating water, for example, so that hot water is obtained as a second type of output from the micro gas turbine. As an alternative, ambient air from an air heating system can be heated by using an air handler, in case forced air heating is used in a building, as is often the case in North America.

In view of practical applications of a micro gas turbine as a micro CHP system, the total efficiency of the micro gas turbine, i.e., the combination of electric efficiency and thermal efficiency, is an important characteristic of the micro gas turbine that is preferably kept as high as possible under all circumstances. In the designing process of a micro gas turbine, a certain operative output value of the electric power is taken into account. In practical situations, such operative output value may be chosen by taking into account a maximum allowable electric current value at the grid inverter, for example, or to another operative limit of one or more components of the micro gas turbine. In any case, the design of the micro gas turbine is optimized in view of the operative output value. This means that in order to realize the highest overall efficiency during actual operation of the micro gas turbine, it is advantageous to ensure that the micro gas turbine is in a mode in which the operative output value of the electric power is actually realized.

If relatively cold ambient air is taken in by the compressor, it happens that the electric power and/or the electric efficiency of the micro gas turbine increase, while the thermal power and/or the thermal efficiency of the micro gas turbine decrease. The first effect can be understood on the basis of the general fact that compressing cold air requires less energy than compressing air of a higher temperature. Also, the operative output value of the electric power is realized at a lower rotational speed of an assembly of the compressor, the turbine and the generator, which will hereinafter be referred to as rotating assembly, as a result of which the volume of air used in the micro gas turbine is reduced and less energy is needed for heating. The second effect can be understood on the basis of the fact that a difference between the temperatures of inlet gas and outlet gas of the micro gas turbine is larger, so that the amount of thermal energy that is lost through an exhaust of the micro gas turbine is increased.

It is an object of the present invention to provide a way of compensating for the reducing effect on the thermal efficiency and/or the thermal power following from an intake of relatively cold ambient air. This object is achieved by means of a micro gas turbine comprising a compressor, a combustor, a turbine, a generator and a controller as mentioned earlier, the controller being configured to repeatedly perform a process comprising steps of allowing hot gas as obtained during operation of the micro gas turbine to flow to the compressor, besides ambient air, checking an actual value related to output electric power of the micro gas turbine, and, when it is found that the actual value related to output electric power is lower than a predetermined operative value, driving the micro gas turbine for increasing a rotational speed of the turbine and the generator until the predetermined operative value related to output electric power is achieved, to increase an extent to which hot gas is allowed to flow to the compressor each time the process is repeated, and to perform the process as long as the rotational speed of the turbine and the generator is below a predetermined maximum value.

Therefore, there is a desire for improved systems and methods related to micro gas turbines. Various embodiments of the present invention address these desires.

### BRIEF SUMMARY OF THE INVENTION

In an exemplary embodiment, the present invention is a micro gas turbine comprising a compressor designed to take in and pressurize gas, a combustor designed to take in pressurized gas from the compressor and to generate hot gas on the basis of fuel combustion, a turbine designed to take in and expand hot gas generated by the combustor, a generator mechanically coupled to the turbine and designed to generate electric power on the basis of mechanical power, a controller designed to control operation of the micro gas turbine, a valve mechanism which is associated with an inlet path to the compressor, a cabinet accommodating at least the compressor, the combustor and the turbine, and a purging mechanism designed to realize purging of the cabinet's interior by supplying air to the cabinet's interior, wherein the valve mechanism is controllable by the controller to open the inlet path of the compressor to the cabinet's interior for enabling the compressor to take in air from the cabinet's interior, and wherein the valve mechanism is also controllable by the controller to open the inlet path of the compressor to an exhaust associated with the turbine for enabling the compressor to take in exhaust gas from the turbine.

In another exemplary embodiment, the present invention is a micro gas turbine comprising a compressor designed to take in and pressurize gas, a combustor designed to take in pressurized gas from the compressor and to generate hot gas on the basis of fuel combustion, a turbine designed to take in and expand hot gas generated by the combustor, a generator mechanically coupled to the turbine and designed to generate electric power on the basis of mechanical power, and a controller designed to control operation of the micro gas turbine, the controller being configured to repeatedly perform a process comprising allowing hot gas as obtained during operation of the micro gas turbine to flow to the compressor, besides ambient air, checking an actual value related to output electric power of the micro gas turbine, when it is found that the actual value related to the output electric power is lower than a predetermined operative value, driving the micro gas turbine for increasing a rotational speed of the turbine and the generator until the predetermined operative value related to output electric power is achieved, to increase an extent to which hot gas is allowed to flow to the compressor each time the process is repeated, and performing the process as long as the rotational speed of the turbine and the generator is below a predetermined maximum value.

In another exemplary embodiment, the present invention is a micro gas turbine comprising a compressor designed to take in and pressurize gas, a combustor designed to take in pressurized gas from the compressor and to generate hot gas on the basis of fuel combustion, a turbine designed to take in and expand hot gas generated by the combustor, a generator mechanically coupled to the turbine and designed to generate electric power on the basis of mechanical power, a controller designed to control operation of the micro gas turbine, a valve mechanism which is associated with an inlet path to the compressor, the valve mechanism being controllable by the controller to open the inlet path of the compressor to hot gas as obtained during operation of the micro gas turbine, a cabinet accommodating at least the compressor, the combustor and the turbine, and a purging mechanism designed to realize purging of the cabinet's interior by supplying air to the cabinet's interior, wherein the valve mechanism is controllable by the controller to open the inlet path of the compressor to the cabinet's interior for enabling the compressor to take in air supplied by the purging mechanism to the cabinet's interior.

In any embodiment of the present invention where it is appropriate, the valve mechanism can comprise a valve and a connection piece having connection areas, the compressor being connected to one of the connection areas of the connection piece through the valve, the exhaust being connected to another of the connection areas of the connection piece, and the cabinet being connected to yet another of the connection areas of the connection piece.

In any embodiment of the present invention where it is appropriate, the connection piece can be Y shaped and comprises two bifurcation legs and a main leg, the compressor being connected to one of the bifurcation legs of the connection piece through the valve, the exhaust being connected to the other of the bifurcation legs of the connection piece, and the cabinet being connected to the main leg of the connection piece.

In any embodiment of the present invention where it is appropriate, the purging mechanism can comprise a ventilating mechanism designed to generate a flow of air in the cabinet.

In any embodiment of the present invention where it is appropriate, the micro gas turbine can further comprise a grid converter designed to output electric power generated by the micro gas turbine during operation thereof to an electric power grid.

In any embodiment of the present invention where it is appropriate, the micro gas turbine can further comprise a heat exchanger being configured and arranged to serve as a recuperator for pre-heating pressurized gas obtained from the compressor before being supplied to the combustor by allowing the pressurized gas to exchange heat with exhaust gas from the exhaust.

In any embodiment of the present invention where it is appropriate, the micro gas turbine can further comprise a heat exchanger being configured and arranged to serve for heating an external medium by allowing the external medium to exchange heat with exhaust gas from the exhaust.

In any embodiment of the present invention where it is appropriate, the controller can further be configured to repeatedly perform a subsequent process once the rotational speed of the turbine and the generator has reached the predetermined maximum value, the subsequent process comprising checking the actual value related to output electric power of the micro gas turbine, and when it is found that the actual value related to the output electric power is lower than the predetermined operative value, decreasing the extent to which hot gas is allowed to flow to the compressor until the predetermined operative value related to output electric power is achieved.

In any embodiment of the present invention where it is appropriate, the controller can further be configured to perform the repeated step of checking the actual value related to output electric power at a predetermined time interval.

In any embodiment of the present invention where it is appropriate, the micro gas turbine can further comprise a valve mechanism which is associated with an inlet path to the compressor, the valve mechanism being controllable by the controller to open the inlet path of the compressor to hot gas as obtained during operation of the micro gas turbine.

In any embodiment of the present invention where it is appropriate, the micro gas turbine can further comprise a cabinet accommodating at least the compressor, the combustor and the turbine, and a purging mechanism designed to realize purging of the cabinet's interior by supplying air to the cabinet's interior, wherein the valve mechanism is controllable by the controller to open the inlet path of the compressor to the cabinet's interior for enabling the compressor to take in air supplied by the purging mechanism to the cabinet's interior.

In any embodiment of the present invention where it is appropriate, the valve mechanism can also be controllable by the controller to open the inlet path of the compressor to an exhaust associated with the turbine for enabling the compressor to take in exhaust gas from the turbine.

In any embodiment of the present invention where it is appropriate, the predetermined operative value related to the output electric power of the micro gas turbine can be linked to a maximum allowable electric current level at the grid converter.

In any embodiment of the present invention where it is appropriate, the micro gas turbine can further comprise a heat exchanger being configured and arranged to serve as a recuperator for pre-heating pressurized gas obtained from the compressor before being supplied to the combustor by allowing the pressurized gas to exchange heat with exhaust gas from the turbine.

In any embodiment of the present invention where it is appropriate, the micro gas turbine can further comprise a heat exchanger being configured and arranged to serve for heating an external medium by allowing the external medium to exchange heat with exhaust gas from the turbine.

In any embodiment of the present invention where it is appropriate, the actual value related to the output electric power of the micro gas turbine can be one of a value of output electric current of the micro gas turbine, and a value of electric efficiency of the micro gas turbine.

According to the various embodiments of the present invention, hot gas as obtained during operation of the micro gas turbine is used for the purpose of improving thermal efficiency and/or thermal power output of the micro gas turbine. The fact is that hot gas is available during operation of the micro gas turbine, and at least a part of the total quantity of hot gas can be used for the purpose of causing a temperature of inlet gas of the compressor to rise. Also, it is checked whether an actual value related to output electric power of the micro gas turbine, such as an actual value of the output electric current or an actual value of the electric efficiency, is below a predetermined operative value. If this appears to be the case, an increase of a rotational speed of the turbine and the generator is realized. By increasing the temperature of the gas that is taken in by the compressor, it is achieved that the electric power level and/or the electric efficiency decrease, which allows for an increase of the rotational speed of the rotating assembly until the point that the predetermined operative value related to output electric power is achieved. As long as the rotational speed of the rotating assembly is not at a predetermined maximum (which is not a mechanical maximum but a maximum in view of optimal total efficiency), the process of realizing a supply of hot gas to the compressor is carried out, wherein steps are taken in which the quantity of the hot gas that is used in the process is increased to a certain extent. Thus, as a result of every new step of the process, it is achieved that the temperature of inlet gas of the compressor is increased, wherein the predetermined operative value related to output electric power is realized at a higher rotational speed of the rotating assembly and thermal efficiency is improved as the amount of thermal energy that is output to the environment is reduced.

The controller is further configured to repeatedly perform a subsequent process once the rotational speed of the turbine and the generator has reached the predetermined maximum value, particularly a process comprising steps of checking an actual value related to output electric power of the micro gas turbine, and, when it is found that the actual value related to the output electric power is lower than the predetermined operative value, decreasing the extent to which hot gas is allowed to flow to the compressor until the predetermined operative value related to output electric power is achieved. Thus, in the situation that operation of the micro gas turbine involves rotation of the rotating assembly at the maximum speed, maintaining the predetermined operative value related to output electric power of the micro gas turbine is done by decreasing the supply of hot gas to the compressor. As power control can no longer be realized by changing the rotational speed of the rotating assembly, the supply of hot gas to the compressor is varied for that purpose. The desired outcome of the controlling process remains the same, namely operating the micro gas turbine so that the rotational speed of the rotating assembly and the output electric power are at, or as near as possible to, values to which the design of the micro gas turbine is optimized as explained earlier. As is the case with the situation in which the rotational speed of the rotating assembly is not yet at the predetermined maximum value, the check of the actual value related to the output electric power against the predetermined operative value can be performed in successive rounds so that a stepwise decrease of the supply of hot gas to the compressor can be realized in the process of approximating the predetermined operative value related to the output electric power and thermal losses can be kept to a minimum level under the circumstances.

It is practical if the controller is configured to perform the repeated step of checking an actual value related to output electric power at a predetermined time interval. Also, it is practical if the micro gas turbine comprises a valve mechanism which is associated with an inlet path to the compressor, the valve mechanism being controllable by the controller to open the inlet path of the compressor to hot gas as obtained during operation of the micro gas turbine.

As mentioned hereinabove, hot gas is available during operation of the micro gas turbine. According to a first feasible option, hot gas can be retrieved from a cabinet of the micro gas turbine in which the compressor, the combustor, the turbine and more components of the micro gas turbine are accommodated, assuming that the micro gas turbine further comprises a purging mechanism designed to realize purging of the cabinet's interior by supplying air to the cabinet's interior. In that case, it is practical for the valve mechanism to be controllable by the controller to open the inlet path of the compressor to the cabinet's interior for enabling the compressor to take in air supplied by the purging mechanism to the cabinet's interior. The fact is that the cabinet's interior is hot during operation of the micro gas turbine due to operation of the combustor and other components of the micro gas turbine. According to a second feasible option, hot gas can be retrieved at a position that is at an outlet side of the turbine, in which case the valve mechanism may be designed so as to be controllable by the controller to open the inlet path of the compressor to an exhaust associated with the turbine for enabling the compressor to take in exhaust gas from the turbine. In the practical case that one or more heat exchangers such as a recuperator and a gas-to-liquid heat exchanger are arranged at the outlet side of the turbine, such an exhaust is positioned downstream of the one or more heat exchangers.

In respect of the second feasible option, it is noted that the air excess ratio of a micro gas turbine having a recuperator is significantly larger than the air excess ratio of conventional internal combustion engines. A typical value of the air to fuel mass ratio of a micro gas turbine, i.e., the mass ratio of air to fuel present in the combustion process taking place in the micro gas turbine during operation thereof, is 90:1. On the one hand, a high mass flow rate of air involves higher heat losses compared to a system working at near stoichiometric combustion conditions. On the other hand, the high mass flow rate of air allows for using the exhaust gas from the turbine as inlet gas of the compressor, as the exhaust gas from the turbine still contains a rather high amount of oxygen.

Within the framework of the present invention, the micro gas turbine may be designed so as to allow for use of hot gas originating from either one or both of the cabinet and the outlet side of the turbine. In the latter case, it is practical for the valve mechanism to comprise a valve and a connection piece having preferably three connection areas, the compressor being connected to one of the connection areas of the connection piece through the valve, the exhaust being connected to another of the connection areas of the connection piece, and the cabinet being connected to yet another of the connection areas of the connection piece. For example, the connection piece may be Y shaped and comprise two bifurcation legs and one main leg, the compressor being connected to one of the bifurcation legs of the connection piece through the valve, the exhaust associated with the turbine being connected to the other of the bifurcation legs of the connection piece, and the cabinet being connected to the main leg of the connection piece. In such a case, there is no need for applying complex valve constructions and associated complex control features. Due to operation of the compressor, it is automatically achieved that a slight underpressure prevails at the one of the bifurcation legs of the connection piece. Further, assuming that the purging mechanism comprises a ventilating mechanism designed to generate a flow of air in the cabinet, it is automatically achieved that a higher pressure prevails at the other of the bifurcation legs of the connection piece. As a result, when the valve is opened, a flow of hot air from the cabinet to the compressor is enabled. By opening the valve further and further, it is eventually achieved that a flow of hot gas originating from the turbine is sucked in as well. In this configuration, if the valve is closed, the normal situation of the air from the cabinet being discharged along with the exhaust gas from the turbine is realized.

A Y shaped connection piece is just one example of a component that may be applied in a practical embodiment of the valve mechanism. Alternatively, a T shaped connection piece or another connection piece having three legs/branches may be used, for example.

As mentioned hereinabove, in practical cases, the micro gas turbine further comprises a grid converter designed to output electric power generated by the micro gas turbine during operation thereof to an electric power grid. According to one possibility, the predetermined operative value related to the output electric power of the micro gas turbine may be chosen in relation to a maximum allowable current level at the grid converter, i.e., may be linked to the maximum allowable current level at the grid converter.

It follows from the foregoing that the present invention provides an algorithm for controlling the micro gas turbine so as to achieve that thermal efficiency of the micro gas turbine during operation thereof is kept optimal under various circumstances. In particular, the present invention provides measures for improving thermal efficiency in case the ambient air that is to be supplied to the compressor is relatively cold. A practical example of a value of the temperature that is taken as an assumption during the designing process of the micro gas turbine is 15° C. Practical examples of maximum/optimal values of the rotational speed of the rotating assembly and an output electric current of the grid converter are 240,000 rpm and 14 A, respectively, wherein it is noted that these values may be associated with a micro gas turbine for generating about 3 kW electrical power.

The micro gas turbine according to the present invention may be of any practical type. In that respect, it is noted that the micro gas turbine may comprise a heat exchanger being configured and arranged to serve as a recuperator for pre-heating pressurized gas obtained from the compressor before being supplied to the combustor by allowing the pressurized gas to exchange heat with exhaust gas from the turbine, as is common in the field of micro gas turbines. Likewise, the micro gas turbine may comprise a heat exchanger being configured and arranged to serve for heating an external medium by allowing the external medium to exchange heat with exhaust gas from the turbine.

These and other aspects of the present invention are described in the Detailed Description of the Invention below and the accompanying figures. Other aspects and features of embodiments of the present invention will become apparent to those of ordinary skill in the art upon reviewing the following description of specific, exemplary embodiments of the present invention in concert with the figures. While features of the present invention may be discussed relative to certain embodiments and figures, all embodiments of the present invention can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present invention.

### BRIEF DESCRIPTION OF THE DRAWINGS

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner.

FIG. 1 shows a scheme of various components of a micro gas turbine according to the invention.

FIG. 2 diagrammatically shows a Y shaped connection piece and a valve as may be part of a valve mechanism of the micro gas turbine.

FIGS. 3-5 illustrate exemplary embodiments of process steps a controller uses to control operation of the micro gas turbine.

### DETAILED DESCRIPTION OF THE INVENTION

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

The figures relate to a micro gas turbine 1 having features according to the invention, as will now be explained. The micro gas turbine 1 as shown and described represents only one example of many possibilities existing within the framework of the invention.

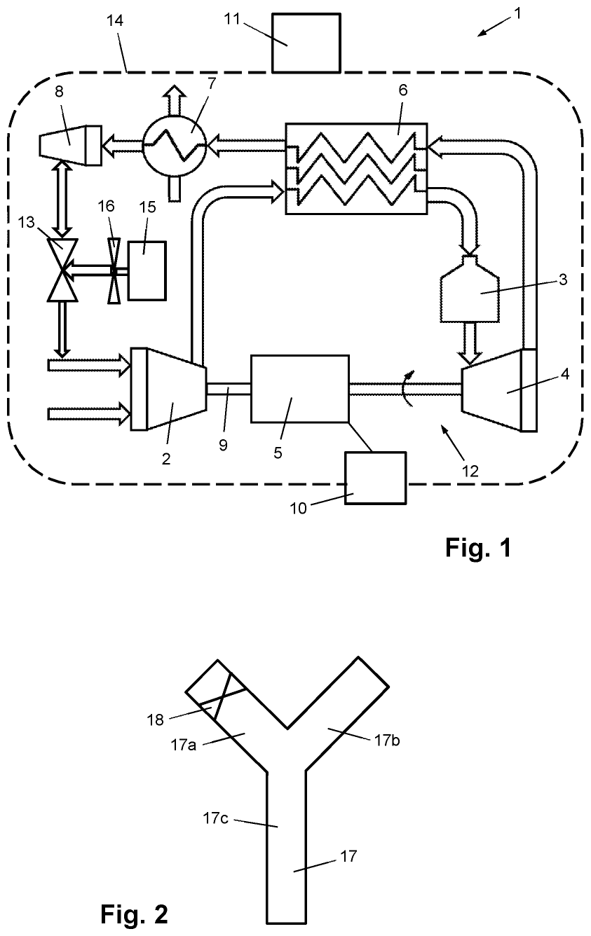

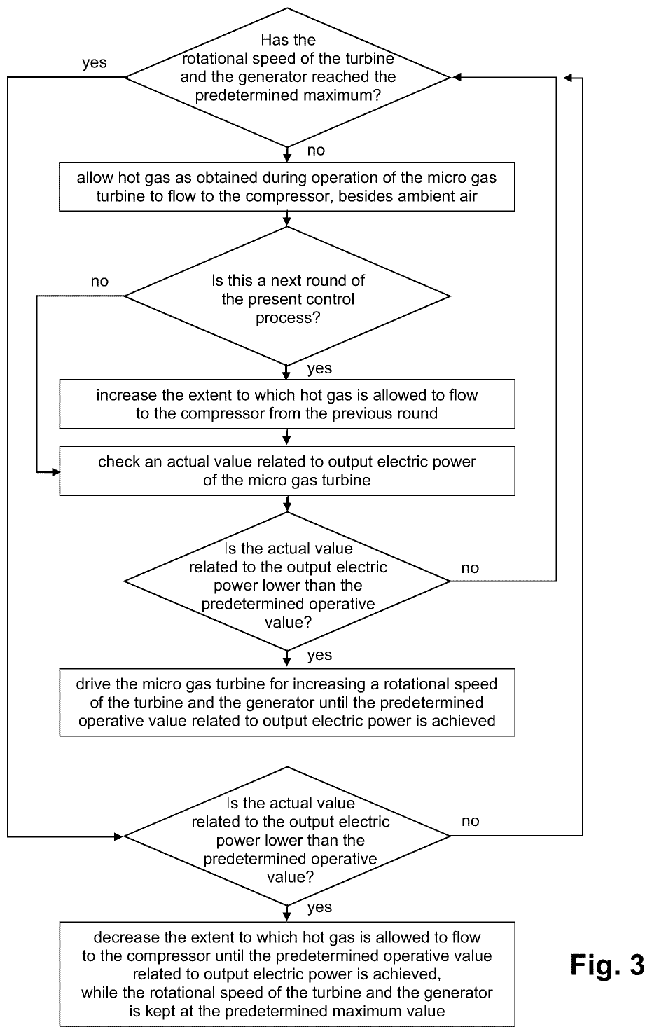

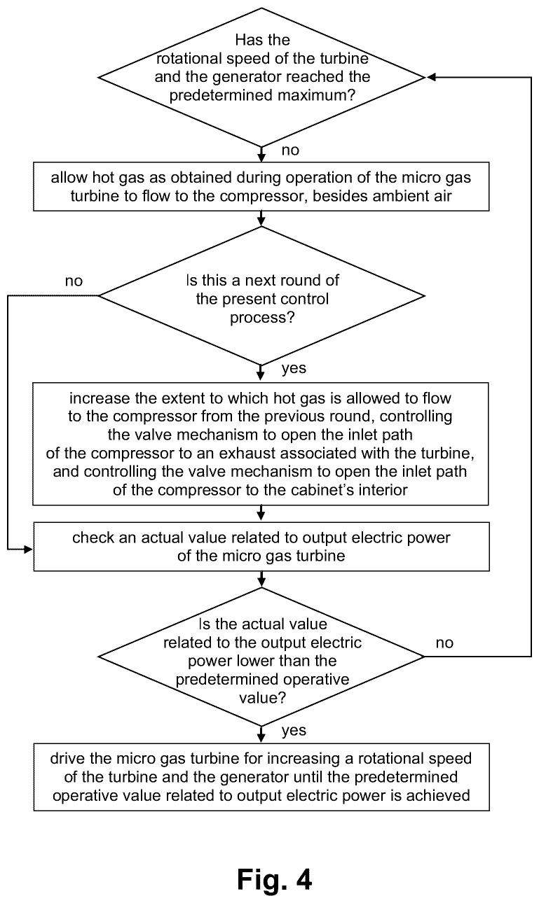

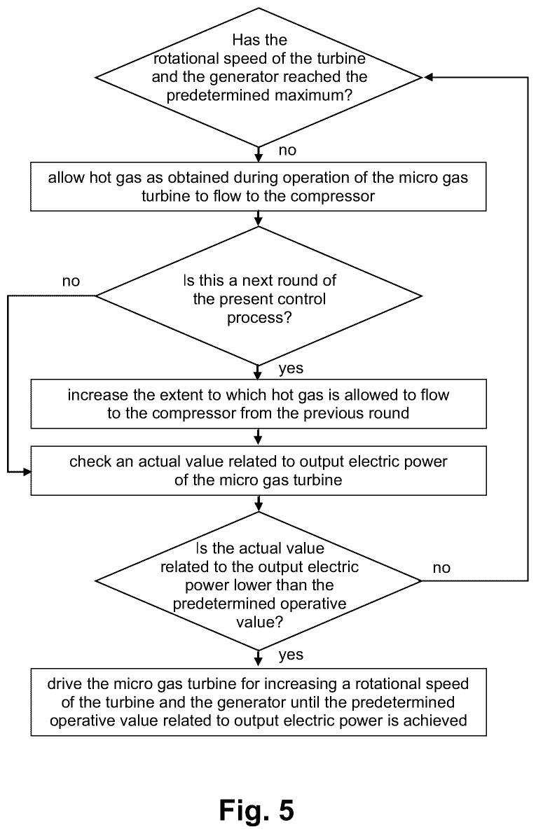

FIG. 1 shows a scheme of various components of the micro gas turbine 1, wherein fluid flows are indicated by means of large arrows. The micro gas turbine 1 may be dimensioned to generate up to 30 KW electrical power, for example, although lower electric power values are possible as well. The micro gas turbine 1 comprises a compressor 2, a combustor 3, a turbine 4, a high speed generator 5, a recuperator 6, a heat exchanger 7 and an exhaust 8. The high speed generator 5 is arranged on a common shaft 9 of the compressor 2 and the turbine 4. When the micro gas turbine 1 is operated, air is input to the compressor 2 and fuel is input to the combustor 3. The compressor 2 acts to compress the air and to thereby pressurize the air, wherein the pressure of the air may be increased to about 3 bar, for example. The compressed air is supplied to the recuperator 6 where it is pre-heated under the influence of heat exchange with exhaust gas from the turbine 4. The compressed air is further heated under the influence of heat generated by fuel combustion in the combustor 3. The hot pressurized gas is expanded in the turbine 4, on the basis of which mechanical power is obtained that is used for powering both the compressor 2 and the high speed generator 5. In the process, the common shaft 9 performs a rotational movement as indicated by means of a small bent arrow in FIG. 1.

Exhaust gas from the turbine 4 is supplied to the recuperator 6 for heating compressed air from the compressor 2, as mentioned. After having passed the recuperator 6, the gas from the turbine 4 is made to flow through the heat exchanger 7 and finally through the exhaust 8. The heat exchanger 7 serves to heat a suitable medium such as water. Thus, output of the micro gas turbine 1 is realized at the heat exchanger 7, and also at the high speed generator 5. In respect of the latter, it is noted that the high speed generator 5 is designed to be used to generate electric current on the basis of mechanical power, and that the micro gas turbine 1 further comprises a grid converter 10 for outputting the electric current to an electric power grid (not shown).

For the purpose of controlling operation of the micro gas turbine 1, a controller 11 is provided. The controller 11 is configured to take care that all functionalities of the micro gas turbine 1 are performed in an appropriate manner so as to realize operation of the micro gas turbine 1 as envisaged. The controller 11 sets a rotational speed of the rotating assembly 12 of the compressor 2, the turbine 4, the high speed generator 5 and the common shaft 9, and controls a supply of fuel to the combustor 3, to mention only two examples.

It is advantageous if the micro gas turbine 1 can be operated under conditions as taken into account during the designing process of the micro gas turbine 1, assuming that the design of the micro gas turbine 1 is optimized to those conditions, so that the total efficiency of the micro gas turbine 1 is optimal at those conditions. However, the practical fact is that out of those conditions, the temperature of the ambient air to be taken in by the compressor 2 is a variable factor. Deviation of the actual temperature of the ambient air from a reference design temperature, which may be 15° C., for example, involves a reduction of thermal efficiency of the micro gas turbine 1. In order to compensate for this phenomenon, at least as much as possible in case the actual temperature of the ambient air is lower than the reference design temperature, the micro gas turbine 1 is equipped with a valve mechanism 13.

In the shown example, the valve mechanism 13 is associated with an inlet side of the compressor 2, with the exhaust 8, and with a cabinet 14 in which various components of the micro gas turbine 1, including the compressor 2, the combustor 3 and the turbine 4, are accommodated. The valve mechanism 13 comprises at least one valve at a position between the inlet side of the compressor 2 on the one hand and the exhaust 8 and the cabinet 14 on the other hand. Also, the micro gas turbine 1 comprises a purging mechanism 15 including a fan 16 for supplying purging air to the cabinet 14 and generating a flow of the purging air inside the cabinet 14. This is done to minimize a risk of accumulation of inflammable/explosive gases in the cabinet 14 which may take place in case unexpected leaks occur, for example.

When operation of the micro gas turbine 1 is initiated, the controller 11 functions to bring about an increase of the rotational speed of the rotating assembly 12. In the process, at a certain point, the maximum allowable current is reached at the grid inverter 10, at which point the increase of the rotational speed is stopped.

Starting from a fully closed position of the valve mechanism 13, the at least one valve of the valve mechanism 13 is opened in a stepwise fashion, while the output current of the grid inverter 10 is checked. Every time the amount of hot gas supplied to the inlet side of the compressor 2 is increased, the mechanical power level at which the micro gas turbine 1 is operated gets reduced, as a result of which the output current is reduced as well. As soon as the output current reaches a certain minimum allowable value, a process in which the rotational speed of the rotating assembly 12 is increased takes place, after which the supply of hot gas to the inlet side of the compressor 2 is increased and the process which leads to increase of rotational speed of the rotating assembly 12 is started all over again. Hence, by gradually increasing the supply of hot gas to the inlet side of the compressor 2, it is achieved that the rotational speed can be made to approximate the design rotational speed.

For the purpose of checking the level of the output current at the grid converter 10, any suitable means may be applied. The process of gradually opening the at least one valve of the valve mechanism 13 is terminated when the rotational speed of the rotating assembly 12 is at the maximum level. From that moment on, if it is found that the level of the output current of the grid inverter 10 is lower than the highest level and even as low as the minimum level, the valve mechanism 13 is put to a further closed position, while the rotational speed of the rotating assembly 12 is kept at the maximum level. Under those circumstances, it is achieved that due to a decrease of temperature of an intake flow of the compressor 2, the mechanical power level goes up and the level of the output current of the grid inverter 10 is increased.

If the micro gas turbine 1 would not comprise the valve mechanism 13 at a position between the inlet side of the compressor 2, the exhaust 8 and the cabinet 14, and if the controller 11 would not be configured so as to control the valve mechanism 13 in the way as described in the foregoing, thermal efficiency of the micro gas turbine 1 would be at a poor level when the temperature of the ambient air taken in by the compressor 2 would be relatively low, i.e., lower than the reference temperature as taken into account in the design process of the micro gas turbine 1. In order to ensure proper operation of the micro gas turbine 1, a mass flow which is large compared to mass flows used in conventional techniques such as internal combustion is needed, which causes the effect of a low ambient temperature to be significant as a large amount of thermal energy exits the micro gas turbine 1 through the exhaust 8.

By having the valve mechanism 13 and controlling the valve mechanism 13 in a specific manner, it is achieved that the actual operational conditions of the micro gas turbine 1 can be made to approximate the reference design conditions, wherein the thermal efficiency of the micro gas turbine 1 can be kept as high as possible. In particular, controlling the valve mechanism 13 aims at having a rotational speed of the rotating assembly 12 at a predetermined maximum level and at the same time having the output electric current of the grid converter 10 at a predetermined operative level. In the process, hot gas as available in the micro gas turbine 1 is used, wherein there is no need for an additional energy flow for achieving a controlling functionality as desired. The hot gas can be taken from the cabinet 14 in view of the fact that the purging mechanism 15 acts to supply air to the cabinet 14 and the fact that the temperature prevailing in the cabinet 14 is high during operation. Alternatively or in addition, the hot gas can be taken from the exhaust 8, in which case the hot gas is exhaust gas from the turbine 4 which is retrieved before exiting the micro gas turbine 1.

In FIG. 2, a possible embodiment of the valve mechanism 13 is illustrated. In particular, a Y shaped connection piece 17 and a valve 18 as may be part of the valve mechanism 13 are shown. The valve 18 is arranged at one of the bifurcation legs 17a, 17b of the connection piece 17, i.e., a bifurcation leg 17a which is shown at the left side in the representation as shown in FIG. 2, and which will hereinafter be referred to as compressor leg 17a. The other of the bifurcation legs 17a, 17b of the connection piece 17, i.e., a bifurcation leg 17b which is shown at the right side in the representation as shown in FIG. 2, serves for connection of the valve mechanism 13 to the exhaust 8, and will hereinafter be referred to as exhaust leg 17b. The main leg 17c of the connection piece 17 serves for connecting the valve mechanism 13 to the cabinet 14, and will hereinafter be referred to as cabinet leg 17c.

On the basis of the flow which is created by the compressor 2 during operation of the micro gas turbine 1, a slight underpressure is prevailing at an inlet side of the valve 18, i.e., in the compressor leg 17a. Under the influence of operation of the fan 16 of the purging mechanism 15, the pressure prevailing in the cabinet leg 17c is at a higher level, so that an air flow from the cabinet 14 to the compressor 2 is obtained when the valve 18 is opened. When the valve 18 is fully opened, a flow of gas from the exhaust 8 is realized as well, wherein the gas is drawn in through the exhaust leg 17b. If the valve 18 is fully closed or almost fully closed, an air flow from the cabinet 14 to the exhaust 8 will be obtained.

It is noted that the extent to which a temperature of an inlet flow of the compressor 2 is varied is dependent on a number of factors, including the functional position of the valve mechanism 13, a rotational speed of the fan 16 of the purging mechanism 15 (which may be dependent on the temperature prevailing in the cabinet 14), the rotational speed of the rotating assembly 12, and the temperature of the medium that is heated in the heat exchanger 7 as this temperature determines the temperature of the hot gas at the exhaust 8 and also, to some extent, the temperature prevailing in the cabinet 14.

It follows from the foregoing that in the micro gas turbine 1 according to the invention, advantageous use can be made of the presence of a purging

mechanism 15 comprising a fan 16. The relatively hot air from the cabinet 14 can be used in a process of keeping the thermal efficiency at an optimal level during operation of the micro gas turbine 1. Also, the exhaust gas from the turbine 4 can be used in the process as mentioned, wherein advantageous use is made of the fact that the level of oxygen of the exhaust gas is still rather high even though the gas is output from an assembly including a combustor 3.

It will be clear to a person skilled in the art that the scope of the invention is not limited to the examples discussed in the foregoing, but that several amendments and modifications thereof are possible without deviating from the scope of the invention as defined in the attached claims.

For the sake of completeness, it is noted that where aspects of the invention like “the rotational speed of the rotating assembly 12 is at the maximum level” are mentioned, these are to be understood for their practical meaning, taking into account that in fact a tolerance window is applicable.

A possible summary of the invention reads follows. When the temperature of ambient air is relatively low, thermal output and thermal efficiency of a micro gas turbine 1 decrease. In order to compensate for the loss of thermal efficiency, the micro gas turbine 1 is equipped with a valve mechanism 13 by means of which the operation of the micro gas turbine 1 can be influenced and optimized, particularly by regulating a supply of hot gas as obtained during operation of the micro gas turbine 1, which may be hot gas from the cabinet 14 and/or the exhaust 8 of the micro gas turbine 1, for example, to an inlet side of the compressor 2. The concept of having a possibility of supplying hot gas from the cabinet 14 to the inlet side of the compressor 2 is not necessarily linked to a particular way of controlling operation of the micro gas turbine 1. In view thereof, the invention also relates to a micro gas turbine 1 comprising a compressor 2 designed to take in and pressurize gas, a combustor 3 designed to take in pressurized gas from the compressor 2 and to generate hot gas on the basis of fuel combustion, a turbine 4 designed to take in and expand hot gas generated by the combustor 3, a generator 5 mechanically coupled to the turbine 4 and designed to generate electric power on the basis of mechanical power, a controller 11 designed to control operation of the micro gas turbine 1, a valve mechanism 13 which is associated with an inlet path to the compressor 2, the valve mechanism 13 being controllable by the controller 11 to open the inlet path of the compressor 2 to hot gas as obtained during operation of the micro gas turbine 1, a cabinet 14 accommodating at least the compressor 2, the combustor 3 and the turbine 4, and a purging mechanism 15 designed to realize purging of the cabinet's interior by supplying air to the cabinet's interior, wherein the valve mechanism 13 is controllable by the controller 11 to open the inlet path of the compressor 2 to the cabinet's interior for enabling the compressor 2 to take in air supplied by the purging mechanism 15 to the cabinet's interior.

Using air from the cabinet's interior as a default option and only additionally using exhaust air originating from the turbine 4 when such is necessary to achieve a certain supply of hot gas to the inlet side of the compressor 2 is advantageous over only using exhaust air originating from the turbine 4. In this way, heat losses through discharge of air from the cabinet's interior are kept limited. Also, air from the cabinet's interior has a higher content of oxygen and a lower content of combustion products than exhaust air originating from the turbine 4, so that it is better suited to be used in the fuel combustion process in the combustor 3.

Further, the invention relates to a possibility of supplying hot gas from the cabinet 14 to the inlet side of the compressor 2 without necessarily using a valve mechanism 13. In view thereof, the invention also relates to a micro gas turbine 1 comprising a compressor 2 designed to take in and pressurize gas, a combustor 3 designed to take in pressurized gas from the compressor 2 and to generate hot gas on the basis of fuel combustion, a turbine 4 designed to take in and expand hot gas generated by the combustor 3, a generator 5 mechanically coupled to the turbine 4 and designed to generate electric power on the basis of mechanical power, a cabinet 14 accommodating at least the compressor 2, the combustor 3 and the turbine 4, and a purging mechanism 15 designed to realize purging of the cabinet's interior by supplying air to the cabinet's interior, wherein an inlet path of the compressor 2 is open to the cabinet's interior for enabling the compressor 2 to take in air supplied by the purging mechanism 15 to the cabinet's interior.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. Instead, it is intended that the invention is defined by the claims appended hereto.

What is claimed is:

1. A micro gas turbine comprising:
a compressor configured to take in and pressurize gas;
a combustor configured to:
take in pressurized gas from the compressor; and
generate hot gas on the basis of fuel combustion;
a turbine configured to take in and expand hot gas generated by the combustor;
a generator mechanically coupled to the turbine and configured to generate electric power on the basis of mechanical power;
a controller configured to control operation of the micro gas turbine;
a valve mechanism which is associated with an inlet path to the compressor;
a cabinet accommodating at least the compressor, the combustor and the turbine; and
a purging mechanism configured to purge an interior of the cabinet by supplying air to the interior of the cabinet;
wherein the valve mechanism is controllable by the controller to open the inlet path of the compressor:
to the interior of the cabinet for enabling the compressor to take in air from the interior of the cabinet; and
to an exhaust associated with the turbine for enabling the compressor to take in exhaust gas from the turbine.

2. The micro gas turbine of claim 1, wherein:
the valve mechanism comprises:
a valve; and
a connection piece having connection areas;
the compressor is connected to a first one of the connection areas of the connection piece through the valve;
the exhaust is connected to a second one of the connection areas of the connection piece; and
the cabinet is connected to a third one of the connection areas of the connection piece.

3. The micro gas turbine of claim 1, wherein the controller is further configured to:
repeatedly perform a process comprising:
controlling the valve mechanism to allow air from at least one of the cabinet or exhaust gas from the exhaust to flow to the compressor, besides ambient air;
checking an actual value related to output electric power of the micro gas turbine; and
when it is found that the actual value related to the output electric power is lower than a predetermined operative value, driving the micro gas turbine for increasing a rotational speed of the turbine and the generator until the predetermined operative value related to the output electric power is achieved;
increase a supply of the air from at least one of the cabinet or exhaust gas from the exhaust to the inlet path of the compressor each time the process is repeated; and
perform the process as long as the rotational speed of the turbine and the generator is below a predetermined maximum value.

4. The micro gas turbine of claim 5, wherein the controller is further configured to repeatedly perform a subsequent process once the rotational speed of the turbine and the generator has reached the predetermined maximum value, the subsequent process comprising:
checking an actual value related to the output electric power of the micro gas turbine; and
when it is found that the actual value related to the output electric power is lower than the predetermined operative value, controlling the valve mechanism to decrease the supply of the air from the at least one of the cabinet or exhaust gas from the exhaust to the inlet path of the compressor until the predetermined operative value related to the output electric power is achieved.

5. The micro gas turbine of claim 1 further comprising a grid converter configured to output electric power generated by the micro gas turbine during operation thereof to an electric power grid.

6. The micro gas turbine of claim 1 further comprising a heat exchanger configured and arranged to serve as a recuperator for pre-heating pressurized gas obtained from the compressor before being supplied to the combustor by allowing the pressurized gas to exchange heat with exhaust gas from the exhaust.

7. The micro gas turbine of claim 1 further comprising a heat exchanger configured and arranged to serve for heating an external medium by allowing the external medium to exchange heat with exhaust gas from the exhaust.

8. The micro gas turbine of claim 1, wherein the purging mechanism comprises a ventilating mechanism configured to generate a flow of air in the cabinet.

9. The micro gas turbine of claim 2, wherein:
the connection piece is Y shaped and comprises bifurcation legs and a main leg;
the compressor is connected to a first one of the bifurcation legs of the connection piece through the valve;
the exhaust is connected to a second of the bifurcation legs of the connection piece; and
the cabinet is connected to the main leg of the connection piece.

10. The micro gas turbine of claim 3, wherein the controller is further configured to perform the repeated step of checking an actual value related to the output electric power at a predetermined time interval.

11. The micro gas turbine of claim 3, wherein the value related to the output electric power of the micro gas turbine is one of a value of output electric current of the micro gas turbine and a value of electric efficiency of the micro gas turbine.

12. The micro gas turbine of claim 4, wherein the controller is further configured to perform the repeated step of checking an actual value related to the output electric power at a predetermined time interval.

13. The micro gas turbine of claim 4, wherein the value related to the output electric power of the micro gas turbine is one of a value of output electric current of the micro gas turbine and a value of electric efficiency of the micro gas turbine.

14. A micro gas turbine comprising:
a compressor configured to take in and pressurize gas;
a combustor configured to:
take in pressurized gas from the compressor; and
generate hot gas on the basis of fuel combustion;
a turbine configured to take in and expand hot gas generated by the combustor;
a generator mechanically coupled to the turbine and configured to generate electric power on the basis of mechanical power;
a controller configured to control operation of the micro gas turbine;
a valve mechanism which is associated with an inlet path to the compressor, the valve mechanism comprising a valve and a connection piece having three connection areas;
a cabinet accommodating at least the compressor, the combustor and the turbine, the cabinet is connected to a respective one of the connection areas of the connection piece; and
a purging mechanism configured to purge an interior of the cabinet by supplying air to the interior of the cabinet;
wherein the valve mechanism is controllable by the controller to open the inlet path of the compressor:
to the interior of the cabinet for enabling the compressor to take in air from the interior of the cabinet; and
to an exhaust connected to another respective one of the connection areas of the connection piece and associated with the turbine for enabling the compressor to take in exhaust gas from the turbine; and
wherein the compressor is connected to another respective one of the connection areas of the connection piece through the valve.

15. The micro gas turbine of claim 14, wherein:
the connection piece is Y shaped;
the three connection areas comprise two bifurcation legs and a main leg of the Y shaped connection piece;
the compressor is connected to a first one of the two bifurcation legs of the Y shaped connection piece through the valve;
the exhaust is connected to a second of the two bifurcation legs of the Y shaped connection piece; and
the cabinet is connected to the main leg of the Y shaped connection piece.

16. The micro gas turbine of claim 15, wherein the purging mechanism comprises a ventilating mechanism configured to generate a flow of air in the cabinet.

17. The micro gas turbine of claim 16 further comprising at least one of:
a grid converter configured to output electric power generated by the micro gas turbine during operation thereof to an electric power grid;
a heat exchanger configured and arranged to serve as a recuperator for pre-heating pressurized gas obtained from the compressor before being supplied to the combustor by allowing the pressurized gas to exchange heat with exhaust gas from the exhaust; or
a heat exchanger configured and arranged to serve for heating an external medium by allowing the external medium to exchange heat with exhaust gas from the exhaust.

18. The micro gas turbine of claim 17, wherein the controller is further configured to:
repeatedly perform a process comprising:
controlling the valve mechanism to allow air from at least one of the cabinet or exhaust gas from the exhaust to flow to the compressor, besides ambient air;
checking an actual value related to output electric power of the micro gas turbine; and
when it is found that the actual value related to the output electric power is lower than a predetermined operative value, driving the micro gas turbine for increasing a rotational speed of the turbine and the generator until the predetermined operative value related to the output electric power is achieved;
increase a supply of the air from at least one of the cabinet or exhaust gas from the exhaust to the inlet path of the compressor each time the process is repeated; and
perform the process as long as the rotational speed of the turbine and the generator is below a predetermined maximum value.

19. The micro gas turbine of claim 18, wherein the controller is further configured to repeatedly perform a subsequent process once the rotational speed of the turbine and the generator has reached the predetermined maximum value, the subsequent process comprising:
checking an actual value related to the output electric power of the micro gas turbine; and
when it is found that the actual value related to the output electric power is lower than the predetermined operative value, controlling the valve mechanism to decrease the supply of the air from the at least one of the cabinet or exhaust gas from the exhaust to the inlet path of the compressor until the predetermined operative value related to the output electric power is achieved.

20. A micro gas turbine comprising:
a compressor configured to take in and pressurize gas;
a combustor configured to:
take in pressurized gas from the compressor; and
generate hot gas on the basis of fuel combustion;
a turbine configured to take in and expand hot gas generated by the combustor;
a generator mechanically coupled to the turbine and configured to generate electric power on the basis of mechanical power;
a controller configured to control operation of the micro gas turbine;
a valve mechanism which is associated with an inlet path to the compressor, the valve mechanism comprising a valve and a Y shaped connection piece comprising two bifurcation legs and a main leg;
a cabinet accommodating at least the compressor, the combustor and the turbine, the cabinet is connected to the main leg of the Y shaped connection piece; and
a purging mechanism configured to purge an interior of the cabinet by supplying air to the interior of the cabinet;
wherein the valve mechanism is controllable by the controller to open the inlet path of the compressor:
to the interior of the cabinet for enabling the compressor to take in air from the interior of the cabinet; and
to an exhaust connected to a respective one of the two bifurcation legs of the Y shaped connection piece and associated with the turbine for enabling the compressor to take in exhaust gas from the turbine; and
wherein the compressor is connected to another respective one of the two bifurcation legs of the Y shaped connection piece through the valve.
